(19) United States
(12) Patent Application Publication
(10) Pub. No.: US 2008/0169359 A1
(43) Pub. Date: Jul. 17, 2008

(54) SHOWERHEAD WITH LIQUID SOAP DISPENSER

(76) Inventors: Paul J. Carrubba, Baldwin, NY (US); Vito James Carlucci, Stratford, CT (US)

Correspondence Address: Lawrence Cruz;Conair Corporation, One Cummings Point Road, STAMFORD, CT, 06902, US

(21) Appl. No.: 11/972,981

(22) Filed: Jan. 11, 2008

Related U.S. Application Data
(60) Provisional application No. 60/880,680, filed on Jan. 15, 2007.

(51) Int. Cl. B05B 7/26; B05B 7/32

(52) U.S. Cl. 239/310; 239/337

(57) ABSTRACT

A showerhead 10 enables a user to selectively mix a liquid such as soap, conditioner or body wash with water. A shower stem connector 12, a mixing chamber 14, and an outlet cap 16 direct water flow. A manual pump 30 and liquid container 32 enable mixing of a liquid such as soap into the water flow.

### CROSS-REFERENCE TO RELATED APPLICATIONS

None.

### BACKGROUND OF THE INVENTION

1. Field of the Invention

The present invention relates to showerhead devices. More particularly, the present invention relates to a wall-mounted or handheld showerhead that dispenses a liquid, such as soap, conditioner or body wash, to the water stream as the water flows through the showerhead.

2. Description of Related Art

It is known in the art to attach showering devices, such as assemblies of multiple showerheads and various moving and water spraying structures to the existing stem pipe supplying water from the standard shower plumbing system. Some shower devices enable a user to mix air with the water flow. However, these devices do not enable a user to selectively mix a liquid such as soap, conditioner or body wash into the water flow.

There is a need for a device that can enable a user to selectively mix a liquid such as soap, conditioner or body wash with the water supply to provide for different shower sensations and options in an effective way, thereby eliminating the need to keep extra bottles and bars of soap, conditioner and/or body wash in the shower area.

### OBJECT AND SUMMARY OF THE INVENTION

It is an object of the present invention to overcome the shortcomings of the prior art mentioned above. These and other objects are achieved by the present invention described herein.

The present invention achieves these and other objectives by providing a showerhead device that enables a user to selectively mix liquid soap with water and includes a shower stem connector, a mixing chamber, and an outlet cap. The showerhead device preferably utilizes a manual pump and a liquid container to mix a liquid such as soap, conditioner or body wash into the water flow.

A pump lever located outside the showerhead enables a user to add a “shot” of liquid soap to the water by depressing a lever arm. As the lever arm is depressed, the pump lever pivots and forces an amount of liquid soap to enter the water stream, whereby the liquid soap and water are mixed. The liquid container is preferably removable so that the container can be refilled with any preferred liquid, such as those purchased at retail.

### BRIEF DESCRIPTION OF THE DRAWINGS

The present invention is more fully understood by reference to the following detailed description of an illustrative embodiment with the drawings identified below.

FIG. 1 is a perspective view of a showerhead device in accordance with a preferred embodiment of the present invention.

FIG. 2 is a side, partial cross-sectional view of the showerhead device in accordance with a preferred embodiment of the present invention.

FIG. 3 is a partial exploded view of the showerhead device in accordance with a preferred embodiment of the present invention.

FIG. 4 is a partial exploded view of the showerhead device in accordance with a preferred embodiment of the present invention.

FIG. 5 is a magnified, partial cross-sectional view of the manual pump of the showerhead device in accordance with a preferred embodiment of the present invention.

FIG. 6 is a partially exploded, cross-sectional view of the showerhead device in accordance with a preferred embodiment of the present invention.

### DETAILED DESCRIPTION OF THE INVENTION

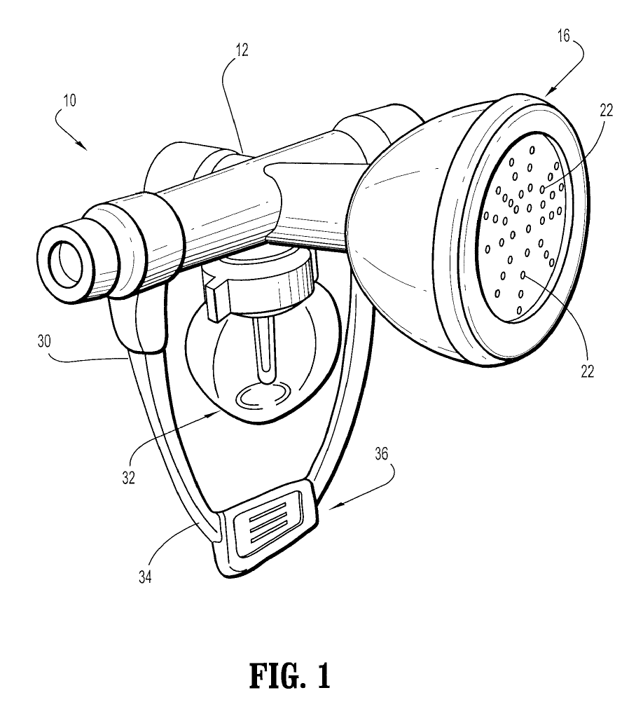

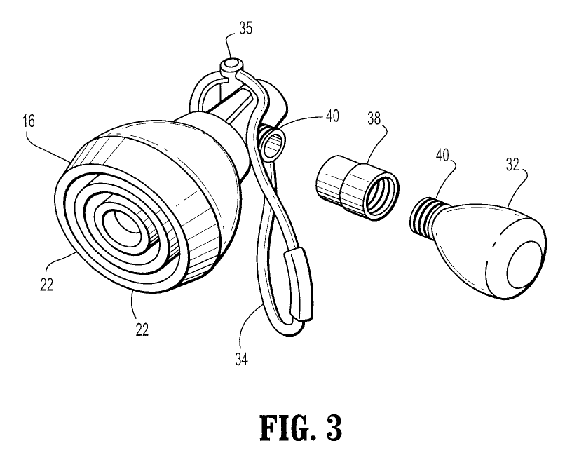

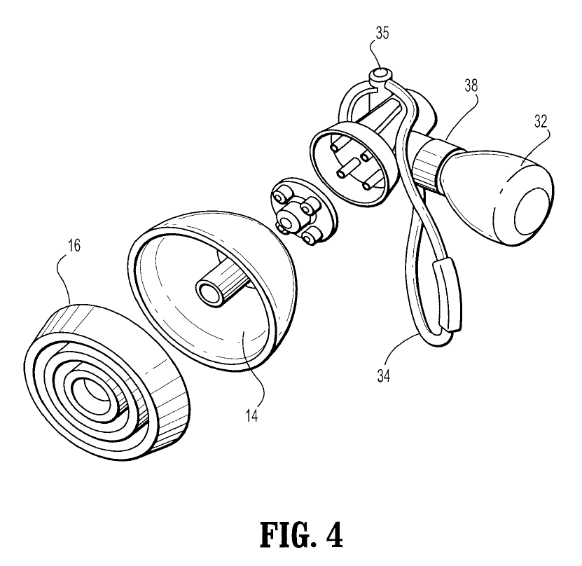

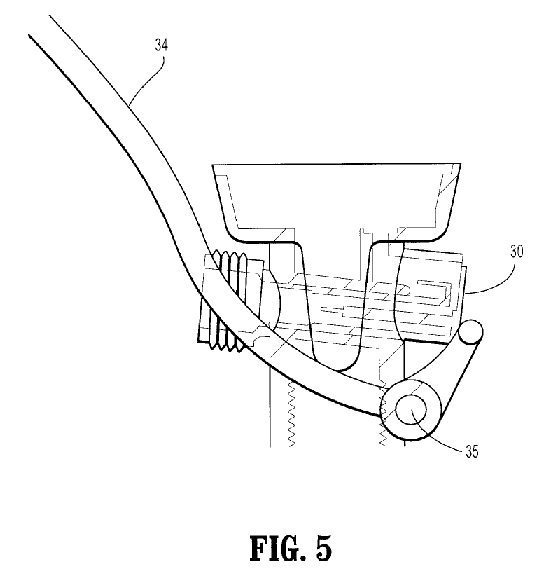

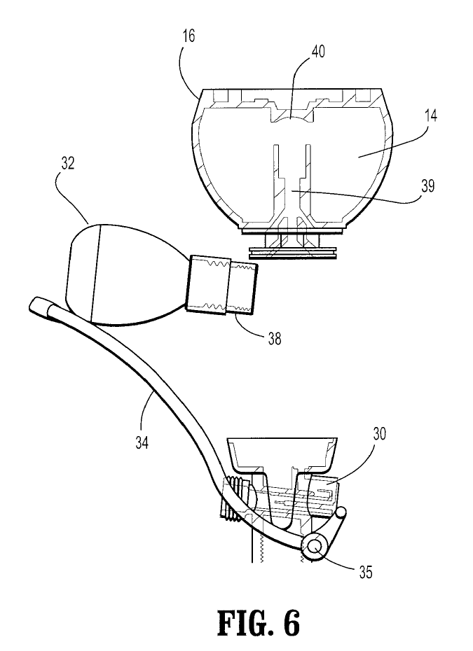

FIGS. 1-6 show a showerhead device 10 in accordance with a preferred embodiment of the present invention. The showerhead device 10 can be ergonomically shaped and include a shower stem connector 12, a mixing chamber 14, and an outlet cap 16. The shower stem connector 12 can include a water inlet 18 to receive water from a standard shower plumbing system. The stem connector 12 can have a number of threads 20 in order to be screwed onto the existing stem pipe. However, any other method of connection can be utilized.

In the preferred embodiment, the outer wall 15 of the mixing chamber 14 is clear or translucent in order to enable a user to see the water and soap as it is being mixed. In an alternate embodiment, the mixing chamber 14 can be opaque.

The outlet cap 16 can be attached to the mixing chamber 14 though the use of screw threads, or any other practical method. In one embodiment, the two components can be fabricated as one piece. The outlet cap has a number of small water outlets 22 to enable the water to flow from the device 10. The water outlets 22 can be in any of a variety of patterns to achieve a variety of spray patterns. In a preferred embodiment, the water outlets 22 can be grouped together in a set of increasingly smaller diameters. The water outlets 22 can all be the same size or can have a number of different sizes. The water outlets 22 can be placed in a predetermined pattern or can be randomly placed on the outlet cap 16.

The showerhead device 10 preferably utilizes a manual pump 30 and liquid container 32 to mix a liquid such as soap into the water flow. The pump 30 is preferably a positive displacement pump and in a preferred embodiment, meters approximately 1-2 grams of liquid soap at a time. A pump lever 34 located outside the showerhead 10 enables a user to add a “shot” of liquid soap to the water by depressing a lever arm 36. As the lever arm 36 is depressed, the pump lever 34 pivots about a hinge 35. This pivoting of the lever 34 pumps an amount of liquid soap out of the liquid container 32 and into the water stream. The liquid soap and water are mixed under the Bernoulli principal, as is known to those skilled in the art.

In a preferred embodiment, the liquid container 32 is attached to the stem connector 12 through a container connector 38. Screw threads 40 can be used to attach the container 32 to the container connector 38 and additional screw threads can be used to connect the container connector 38 to the stem connector 12. The liquid container 32 is preferably removable and can be refilled with any preferred liquid, such as those purchased at retail. In a preferred embodiment, a liquid container 32 may hold between approximately 2 and 6 ounces of liquid.

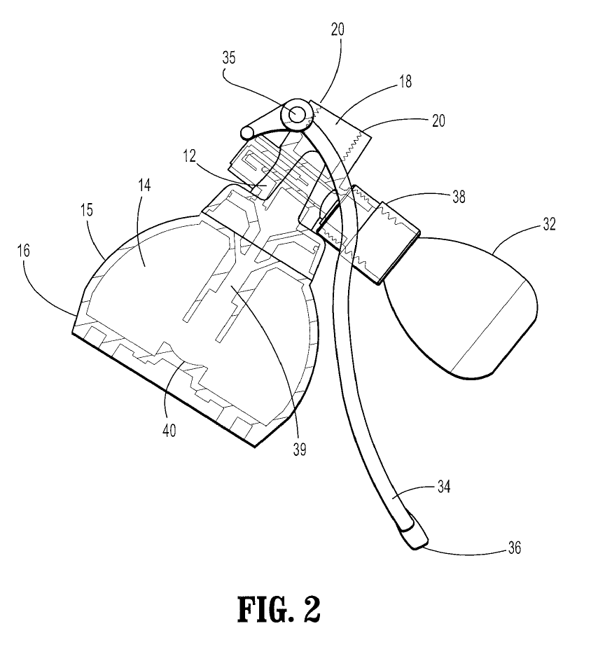

As the liquid soap enters the water stream, the water mixes with the liquid soap and the combination flows through a nozzle 39 and preferably hits a plate 40 on the inner wall of the outlet cap 16 within the mixing chamber 14. FIG. 2 shows a cross-sectional view of the outlet cap 16, illustrating the plate 40. FIG. 2 is a cross-sectional view of one example of the plate 40. The shape of this plate 40 is preferably slightly concave, as shown. However, other shapes can be utilized, such as having a plate that is flat, slightly convex, or semi-spherical, for example.

This mix of water and liquid soap provides for a better shower experience for a user. A user may selectively choose to incorporate soap or other liquid into the water flow and then rinse off by refraining from depressing the lever arm 36. This eliminates the need for a user to keep multiple container of soap, conditioner and/or body wash in the shower area and enables a user to easily incorporate the liquid into the shower experience without having to find and open a separate bottle in the shower area.

While a preferred embodiment of the invention has been herein disclosed and described, it is understood that various modifications can be made without departing from the scope of the invention.

What is claimed is:

1. A shower head assembly comprising
an water inlet port for receiving water under pressure from an external, pressurized water source;
a water path conduit connected to said water inlet port for directing flowing water received through said water inlet port;
a liquid product inlet port connected to said water path conduit at a location downstream from said water inlet port, said liquid product inlet port for introducing a liquid product into said water path conduit;
a liquid product container for storing liquid product, said container being in communication with said liquid product inlet port; and
an outlet nozzle attached to said water path conduit for emitting water or a combination of water and liquid product.

2. An assembly according to claim 1, further comprising
a manually operable control lever for selectively enabling or disabling flow of liquid product from said liquid product container into said water path conduit.

3. An assembly according to claim 1, further comprising
a mixing chamber between said liquid product inlet port and said outlet nozzle for mixing liquid product and water into a mixture, such that said mixture is emitted from said outlet nozzle.

4. An assembly according to claim 1, wherein
said liquid container is removable from said assembly.

5. An assembly according to claim 2, further comprising
a manual pump operatively associated with said control lever for selectively pumping said liquid product from said liquid container into said water path conduit.
